(19) United States
(12) Patent Application Publication
(10) Pub. No.: US 2026/0265482 A1
(43) Pub. Date: Sep. 10, 2026

(54) AN AUGMENTED PROCESS OF CONVERTING A POLYMER TO HYDROCARBON PRODUCTS

(71) Applicant: Nilesh Inamdar, Pune (IN)

(72) Inventor: Nilesh Inamdar, Pune (IN)

(21) Appl. No.: 19/152,971

(22) PCT Filed: Nov. 15, 2024
(86) PCT No.: PCT/IB2024/061409

§ 371 Date: Aug. 1, 2025

(30) Foreign Application Priority Data
Nov. 20, 2023 (IN) 202321078670

(51) Int. Cl. C08J 11/12; C10G 5/06

(52) U.S. Cl. CPC C08J 11/12; C10G 5/06; C08J 2323/06; C08J 2323/12; C08J 2325/06

(57) ABSTRACT

The present disclosure discloses an assembly of an augmented attachments integrated with the process for converting a polymer to one or more hydrocarbon products and the process thereof. The said assembly aims to improve the process efficiency by suitably modifying and introducing new components to the said assembly as compared to existing similar process or technologies in the market.

### CROSS-REFERENCE TO RELATED APPLICATIONS AND PRIORITY

The present application claims priority from Indian Patent Application No. 202321078670, filed on Nov. 20, 2023

### TECHNICAL FIELD

The present subject matter described herein, in general, relates to an augmented attachments integrated in the process for converting a polymer to one or more hydrocarbon products and the process thereof and the process thereof, more particularly, the present subject matter relates to the technical improvement or advancement over an existing process by which the polymer is converted into one or more hydrocarbon products such as an oil, a gas, and a tar, leaving behind less or no waxes (residues) at the end of the said process.

### BACKGROUND

Because most post-consumer plastics cannot be used for the same purpose again, technically and commercially recycling plastic does not “close the loop” way recycling glass or aluminum or other metals does. To recycle plastic waste as it is, it were to serve the same purpose, virgin resin would be added to it to raise the quality. In essence, recycling plastic just delays its inevitable disposal while extending its useful life. All plastic eventually ends up in a landfill or an incinerator.

Numerous technics on converting polymer into hydrocarbon are available in the market today. Despite of all of the technical advances over the recent years in the recovery/processing of plastic materials, there remains a portion of plastic material that cannot be mechanically recycled due to various reasons and technical limitations. However, a new generation of conversion technology specifically designed to tackle problems of non-mechanically recycled plastic materials, most of which are multilayered or metalized, have been developed worldwide. Pyrolysis reaction is used in the conversion technology which converts plastic material to petroleum products. The benefits presented by these conversion technologies are many folds: transforming non-recycled plastic materials into a valuable commodity such as various hydrocarbon or petroleum products, creating reliable source of alternate energy from an abundant, freely available plastic materials especially the plastic waste materials.

Plastic materials are one of the promising resources for fuel/hydrocarbon production because of its composition and easy availability in local vicinity. The conversion technologies depend upon the types of plastic materials to be treated. Additionally, the effective conversion of the plastic material requires appropriate technologies to be selected which gives optimal output at the end of conversion process with high efficiency.

Therefore, there exist few safety and quality concerns during the conversion process such as purity/quality of oil and gas obtained, environment pollution due to exhaust, erosion of components of the processing unit. Additionally, process challenges such as smooth feeding of plastic material to the reactor, effective conversion of the plastic material into the hydrocarbon or petroleum products, traces of solid carbon particles i.e. presence of wax content in output product, and ensuring minimal shutdown/maintenance time.

### SUMMARY

Before the present process(s), composition(s) and product(s), enablement are described, it is to be understood that this disclosure in not limited to the particular processes, compositions, products and methodologies described, as there can be multiple possible embodiments of the present disclosure and which are not expressly illustrated in the present disclosure. It is also to be understood that the terminology used in the description is for the purpose of describing the particular versions or embodiments only, and is not intended to limit the scope of the present disclosure.

The present disclosure discloses an augmented attachments integrated with the process for converting a polymer to one or more hydrocarbon products and the process thereof. The said process comprises of adding the polymer to the Gasolizer 104. The polymer is used in shredded or densified (agglomerated) or granulated form. Further, the process comprises of processing the polymer in the Gasolizer 104, to undergo Gasolysis™ reaction at a predefined temperature of 360° C. to 380° C. at an atmospheric pressure in absence of oxygen. The Gasolysis™ reaction comprises of the process of heating the polymer in presence of a catalyst in the Gasolizer 104. The polymer undergoing the Gasolysis™ reaction generates hydrocarbon vapors comprising oil vapors, a gas and solid carbon particles. Additionally, the process comprises passing of the hydrocarbon vapors from the Gasolizer 104 to a Coke Column 106 in order to separate the solid carbon particles and heavy hydrocarbons which are relatively heavier than the vapors. The said process further comprises of passing of the solid carbon particles to the Gasolizer 104 whereas passing the oil vapors and the gas to a Rectification Column 108. The Rectification Column 108 separates from the oil vapors, high boiling constituents of the oil vapors and low boiling constituents of the oil vapors. The low boiling constituents of the oil vapors and the gas are eventually passed to a Condenser 112. The low boiling constituents of the oil vapors are condensed in the Condenser 112 to obtain the one or more hydrocarbon products. A special packing and Catalytic Metal(s) placed at the Coke Column 106, Rectification Column 108 and Scrubber prevents formation of Sulphur and Chloride compounds. These special packings absorb contaminants such as Chlorine, Sulphur, etc. from the vapors, gases generated therein.

### BRIEF DESCRIPTION OF THE DRAWINGS

The detailed description is described with reference to the accompanying figure. In the figure, the left-most digit(s) of a reference number identifies the figure in which the reference number first appears. The same numbers are used throughout the drawing to refer like features and components.

FIG. 1 illustrates an assembly 100 of an augmented attachments integrated in a process 200 for converting a polymer i.e. a plastic material into mixture of hydrocarbon products, in accordance with an embodiment of the present subject matter.

FIG. 2 illustrates a process 200 for converting a polymer i.e. a plastic material into mixture of hydrocarbon products, in accordance with an embodiment of the present subject matter.

### DETAILED DESCRIPTION

The exemplary embodiments of the present disclosure are described herein in detail, though the present disclosure is not limited to these embodiments. Constituting elements in the embodiments include elements easily achieved by a person skilled in the art, or elements being substantially equivalent to those elements.

The words “comprising”, “having”, “containing”, and “including”, and other forms thereof, are intended to be equivalent in meaning and be open ended in that an item or items following any one of these words is not meant to be an exhaustive listing of such item or items, or meant to be limited to only the listed item or items. It must also be noted that as used herein, the singular forms “a”, “an”, and “the” include plural references unless the context clearly dictates otherwise.

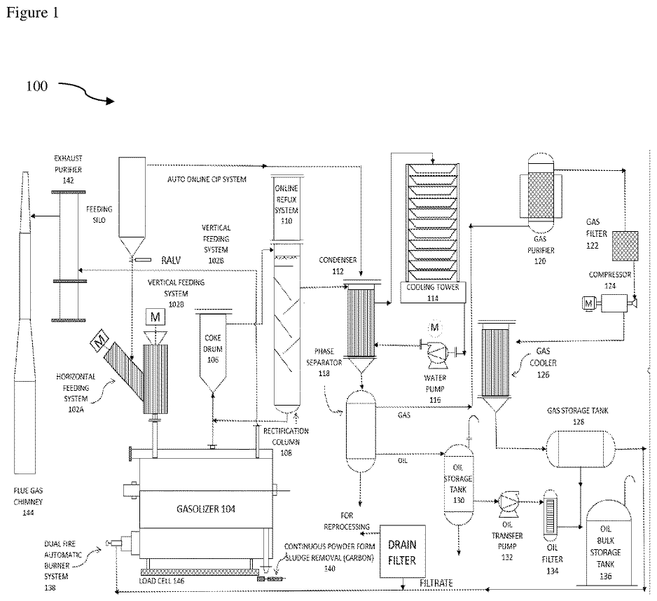

FIG. 1 illustrates an assembly 100 of an augmented attachments integrated in the process 200 for converting a polymer i.e. a plastic material into mixture of hydrocarbon products with improved and more efficient way to ensure less harmful exhaust at the chimney/stack and more pure form of the gas and the liquid hydrocarbon (i.e. oil) which can be reused in the process itself for heating purpose, according to an embodiment of the present disclosure. In the present disclosure, few components are introduced to ensure less maintenance/shutdown time. That means, the process itself take few measures of cleaning and safety precautions.

The polymer may comprise at least one of a Poly Ethylene (PE), High-Density Polyethylene (HDPE), a Low-Density Polyethylene (LDPE), a Polypropylene (PP), a Polystyrene (PS), BOPP, Crosslinked Polymers (XLPE), a very less quantity of Polyvinyl Chloride (PVC) and a Polyethylene Terephthalate (PET), and a plastic waste segregated from municipal solid wastes or multilayer plastic or from industry or a combination thereof. The following description is explained considering the polymer to be plastic material for enabling the disclosure. However, the use of other materials from the polymer category is obvious to those persons skilled in the art and is within the scope of the disclosure. The present subject matter discloses a process comprising heating of the plastic material to undergo a Gasolysis™ reaction in a Gasolizer 104 to obtain one or more hydrocarbon products. The hydrocarbon products include a transportation fuel, furnace oil, or feed to crackers to create plastic again, a residue with carbon/tar and a gas.

According to another embodiment of the present disclosure, the assembly 100 comprises of various components of the augmented attachments integrated in the process 200 for converting a polymer i.e. a plastic material into mixture of hydrocarbon products, such as at least i) a horizontal feeding means 102-A and a vertical feeding means 102-B, ii) the Gasolizer 104, iii) a Coke Column 106, iv) a Rectification Column 108, v) an Online Reflux System 110, vi) a Condenser 112, vii) a Cooling Tower 114, viii) a Water Pump 116, ix) a Phase Separator 118, x) a Gas Purifier 120, xi) a Gas Filter 122, xii) a Compressor 124, xiii) a Gas Cooler 126, xiv) a Gas Storage Tank 128, xv) an Oil Storage Tank 130, xvi) an Oil Transfer Pump 132, xvii) an Oil Filter 134, xviii) a Bulk Storage Tank 136, xix) a Dual Fire (oil & gas) Burner 138, xx) a Sludge Removal Means 140, xxi) an Exhaust Purifier 142, xxii) a Chimney 144, and xxiii) a Load Cell 146. The said process can be described in detail through its various components.

### Vertical Feeding Systems 102

The present disclosure discloses a feeding silo attached to a specially designed feeding systems i.e. at least a vertical feeding system which has been designed to accommodate densified (agglomerated) or granulated plastic waste to the Gasolizer 104. Vertical feeding system 102 (hereinafter together referred to as “the feeding system”), further comprise an internal as well as external cooling arrangement accommodating inert gas infusion in one of the sections. Additionally, the present disclosure discloses the use of specially devised Gate Valves & RALV (Rotary Air Lock Valve) in the feeding systems. Said Valves acts as a sealing arrangement against air/oxygen entering into the Gasolizer 104 as well as cooling and condensing entrained vapors to feeding system. This achieves oxygen deprived state and minimizing risk of high temperature vapors coming out of Gasolizer 104. Moreover, RALV is useful in maintaining a pre-decided flow of polymer material to the feeding system and as a gravity discharger.

### Gasolizer 104

In one embodiment, the Gasolizer 104 is enabled to receive the plastic material through at least a horizontal feeding means 102-A and a vertical feeding means 102-B. The Gasolizer 104 is a catalytic reactor wherein catalyst is added in the ratio of 0.1 to 0.2% with the plastic material to undergo the Gasolysis™ reaction after heating the Gasolizer 104 at a predefined temperature range of 360° C. to 380° C. and at an atmospheric pressure. The present disclosure does not claim improvement in the working and functioning of the Gasolizer 104.

According to one embodiment of the present disclosure, the plastic material for the process may be a Polyethylene (PE), High-Density Polyethylene (HDPE), a Low-Density Polyethylene (LDPE), a Polypropylene (PP), a Polystyrene (PS), BOPP, Crosslinked Polymers (XLPE), a little quantity of Polyvinyl Chloride (PVC) and Polyethylene Terephthalate (PET) or plastic waste segregated from municipal solid wastes, multilayer plastic or industrial plastic waste or a combination thereof. A plastic waste material is preferred for the process. The municipal solid wastes, agriculture wastes, e-wastes comprising the plastic content may also be utilized as a raw material for the process. The plastic material before adding to the Gasolizer 104 may be segregated. Further, the plastic material is usually crushed or shredded or densified (agglomerated) to a size suitable to the size of inlet of the Gasolizer 104. Thereafter the plastic material is added to the Gasolizer 104 through the horizontal feeding means 102-A and the vertical feeding means 102-B or a specially designed vertical feeding system.

In one more embodiment of the present disclosure, the Gasolizer 104 is provided with the Load Cell 146. In the initial stage of the process Liquefied Petroleum Gas (LPG) is used as a pilot flame fuel, start-up fuel and supplementary fuel for providing heat to the Gasolizer 104. As the process goes on, one of the final products of the process is the gas, wherein the gas is stored in the Gas Storage Tank 128 and is used as a heat source to provide heat to the Gasolizer 104 passing via a filtration and pressure reduction valve fitted therein.

In another embodiment of the present disclosure, heating of the plastic material under the predefined pressure and temperature in oxygen-free chamber i.e. Gasolizer 104 facilitates thermal cracking of the polymer (i.e. plastic material) under the Gasolysis™ reaction. In the Gasolysis™ reaction, the thermal cracking takes place, wherein the thermal cracking is the process of converting the polymer into a monomer or a pool containing mixture of the monomers. The long-chain polymer is broken down to shorter chain polymer. Furthermore, due to the thermal cracking of the plastic material, the plastic material is melted and vaporized, thereby generating hydrocarbon vapors inside the Gasolizer 104. The hydrocarbon vapors comprise a mixture of hydrocarbons (monomers) vapors and carbon (sludge) along with lower hydrocarbons i.e. C₁ to C₆ (gaseous phase) and higher hydrocarbons i.e. C₇ to C₃₀ (liquid phase). The Gasolizer 104 is further connected to the Coke Column 106, wherein the generated hydrocarbon vapors (GAS: C1 to C6, GASOLINE: C5-C12, AROMATICS: C6-C8 C9-C12, DIESEL: C12-C15, HEAVIER: C24+, OTHER GASES: H2) are passed to the Coke Column 106.

### Coke Column 106

According to an embodiment of the present disclosure, the Coke Column 106 is enabled to receive the hydrocarbon vapors generated in the Gasolizer 104. The hydrocarbon vapors may comprise of oil vapors, a gas and solid carbon particles. The Coke Column 106, on receiving the hydrocarbon vapors from the Gasolizer 104, is enabled to raise the hydrocarbon vapors inside the Coke Column 106 at a predetermined speed to separate out the entrained solid carbon particles from the hydrocarbon vapors. The Coke Column 106 may be of invert-conical shape, wherein the Coke Column 106 may have the broader area at the top than the bottom. When the hydrocarbon vapors are introduced in the Coke Column 106 from the bottom end the hydrocarbon vapors are exposed to an environment inside the Coke Column 106 where lighter constituents of the hydrocarbon vapors are raised higher than relatively heavier constituents like the solid carbon particle of the hydrocarbon vapors due to density difference and lowering of the speed of the hydrocarbon vapors with which the hydrocarbon vapors entered the Coke Column 106. The relatively lighter hydrocarbon vapors and the gas are taken out from an outlet at the top end of the Coke Column 106 and the relatively lighter hydrocarbon vapors and the gas are transferred to the Rectification Column 108. Whereas, the heavy solid carbon particles which are unable to rise in the height inside the Coke Column 106 due to relatively high density got settled at the bottom of the Coke Column 106 and eventually dropped into the Gasolizer 104 again for re-processing.

The purpose of the Coke Column 106 is of two-fold: the Coke Column 106 re-processes the solid carbon particles from the hydrocarbon vapors which were on way to downstream of the process and secondly the Coke Column 106 ensures elimination of the free solid carbon particles from the one or more hydrocarbon products of the process. According to preferred embodiment of the present disclosure, process of 2500 kg capacity was carried out, wherein amount of the hydrocarbon vapors release was 80 to 90% of total mass of the plastic material in the Gasolizer 104 and whereas the amount of the solid carbon particle was 5 to 10% of total mass of the plastic material in the Gasolizer 104. The Coke Column 106 separates 5 to 10% of the solid carbon particles and sent back the solid carbon particles to the Gasolizer 104 for re-processing. The solid carbon particles generally form wax during the process, wherein the wax formed blocks inlet and outlet of the Rectification Column 108 and frequent removal/cleaning of the wax from the inlet and the outlet of the Rectification Column 108 increases maintenance cost of plant on which the process is being carried out. Therefore, by minimizing the traces of the solid carbon particles, the wax formation in the Rectification Column 108 has been reduced. Further, the chances of obtaining the traces of the solid carbon particles in the output product i.e. the one or more hydrocarbon products are also minimized. Coke Column 106 also incorporates special metal packings along with catalyst to remove traces of chlorine and Sulphur contamination.

### Rectification Column 108

In one embodiment of the present disclosure the Rectification Column 108 is enabled to receive the hydrocarbon vapors from the Coke Column 106. The hydrocarbon vapors comprise of the oil vapors and the gas and when the hydrocarbon vapors are passed through the Rectification Column 108, the Rectification Column 108 separates high boiling constituents and low boiling constituents of the oil vapors. The Rectification Column 108 works on the principal of distillation for separating out the high boiling constituents and the low boiling constituents of the oil vapor. The fractioning process is carried out inside the Rectification Column 108. After the separation, the low boiling constituents are the passed to the Online Reflux System 110. Rectification Column 108 top is incorporated with special metal packings along with catalyst to remove traces of chlorine and Sulphur contamination.

Heavy tails and deposition at the bottom of Rectification Column 108 is taken back to Gasolyser 104 through specially designed screw for reprocessing.

### Online Reflux System 110

In technical terms reflux is a technique involving the condensation of vapors and the return of this condensate to the system from which it originated. The main purpose of the Online Reflux System 110 is to maintain temperature in a controlled manner at a constant temperature. Additionally, Online Reflux System 110 facilitates down-flowing liquid throughout the rectification section to contact with the upward flowing vapor in order to achieve stage-by-stage equilibrium heat and mass transfer and hence purification of the products accumulated at the top section of the online reflux system 110.

### Condenser 112

In one embodiment of the present disclosure the condenser 112 is vertically mounted. A separate Cooling Tower 114 is mounted to cool the Condenser 112. In one of the embodiments, the Condenser 112 used is shell and tube type, wherein the shell side is provided with cold water circulation. During the condensation, i.e. the gas (i.e. non-condensable) are separated & oil (i.e. condensable) as one or more hydrocarbon products. The oil & the gas are thereafter carried towards the Phase Separator 118 in the next stage of the process.

### Phase Separator—I 118

In one embodiment of the present disclosure, the Phase Separator 118 is enabled to receive the one or more hydrocarbon products and the gases from the Condenser 112. The one or more hydrocarbon product and the gas are stored in the Phase Separator 118 for time period to separate out one or more hydrocarbon products and the gas. After expiry of a predefined time period, the one or more hydrocarbon products are pumped out from the bottom of the Phase Separator 118 using an Oil Transfer Pump 132. The Oil Transfer Pump 132 transfers and stores the one or more hydrocarbon products in the Bulk Storage Tank 136 after a due filtration through the Oil Filter 134. Additionally, oil obtained may have pH on higher scale. Hence, stabilization of the oil obtained from the Phase Separator 118 is achieved by circulating chemicals throughout to neutralize the pH of the oil and oil washing. The chemical used here would be acid or base or other additives. The one or more hydrocarbon products are used in various industries as a furnace fuel or as a fuel in diesel engines. Furthermore, the gas from the Phase Separator 118 are passed to the Gas Scrubber 120.

### Phase Separator—II 118

In one embodiment of the present disclosure, the Phase Separator II 118 is enabled to receive mixture of hydrocarbons (OIL) from the Phase Separator I 118. The mixture of hydrocarbons (OIL) is stored in the Phase Separator 118 for time period to separate Oil and water (Condensed Moisture). After expiry of a predefined time period, oil is pumped out from the upper bottom of the Phase Separator II 118 using an Oil Transfer Pump 132 and water (moisture) is drained for further treatment.

### Gas Purifier 120

In one embodiment of the present disclosure, the Gas Purifier 120 is used in process-air applications to eliminate potentially contaminants such as harmful dust, aerosols and pollutants. The present disclosure discusses an improvement in the Gas Purifier 120 used in earlier. Instead of using liquid, the improved impounding means i.e. the Gas Purifier 120 adopts a use of a packing/bed of special metal packings comprising of special material, wherein it has been scientifically observed that in plastic pyrolysis process Sulphur content is present in gas stream. The said impounding means i.e. the Gas Purifier 120 helps in arresting unwanted contaminants from the hydrocarbon vapors and the gas. Said contaminants react with the metal packings inside the Gas Purifier 120 and transform into new form which in turn reduces or eliminates its traces in the next step of the process 200. Further, in presence of Sulphur and chlorine, metal reacts with it to return to its original state of metal sulphate which is the purest form metal. Moreover, the Gas Purifier 120 removes traces of liquid droplets from the stream of gases of the hydrocarbon vapor to protect downstream equipment in the process from damage and failure. It is typically used at the upstream stage of process that contains dry desiccants or mechanical equipment such as compressors like the one Compressor 124 is used in the process. After treating the un-condensed gases in the Gas Purifier 120, the un-condensed gases are passed through the Gas Cooler 126 to bring down the gas temperature a bit. Thereafter the cooled gas can be stored in the Gas Storage Tank 128 via the Compressor 124, wherein the Compressor 124 compresses the gas for further use in the process as a source of energy.

In another embodiment of the present disclosure, the supplementary fuel (Liquefied Petroleum Gas (LPG) or High Speed Diesel (HSD)) is used as a start-up fuel to begin the process. Moreover, once the sufficient amount of the compressed gas stored in the Gas Storage Tank 128 is available it is used as a source of heat for the Gasolizer 104 in place of the supplementary Fuel. By utilizing the output of the process as the source energy makes the process a closed loop and energy efficient with the environment dully taken care of. For this reason, the Dual Fire Burner 138 is installed to the Gasolizer 104.

In another embodiment of the present disclosure after completing the process, sludge formed during the process is removed through the Sludge Removal Means 140 attached to the Gasolizer 104. The sludge formed after the process contains carbon waste, tar, metal scrap and other wastes. Few ingredients from the sludge are utilized in various industries like carbon waste after cooling in powder form can be best used as fuel in solid fuel fired boilers, road construction etc. with few additives. The metal scrap can be recycled and re-used.

In another embodiment of the present disclosure the weight of the plastic material inside the reactor is weighed by enabling the Load Cell 146. The Load Cell 146 is placed beneath the Gasolizer 104 which ensures correct amount of material going to Gasolizer 104 and eventually safe operation of the Gasolizer 104.

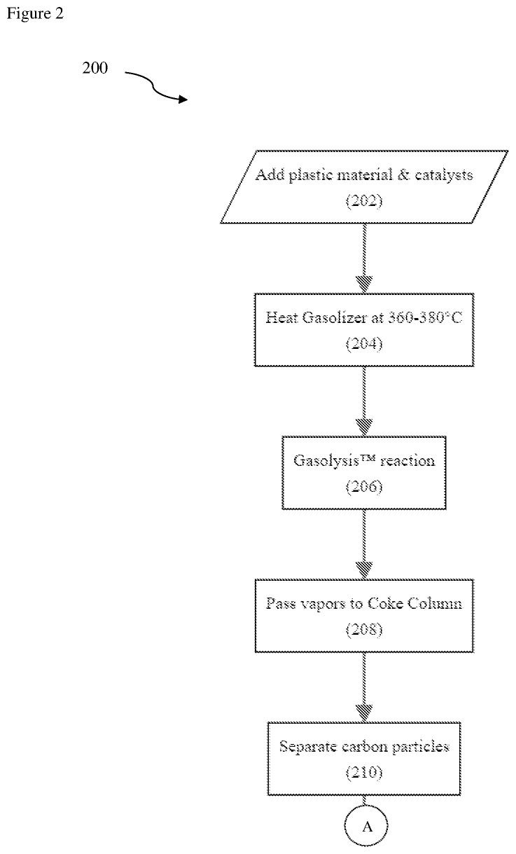

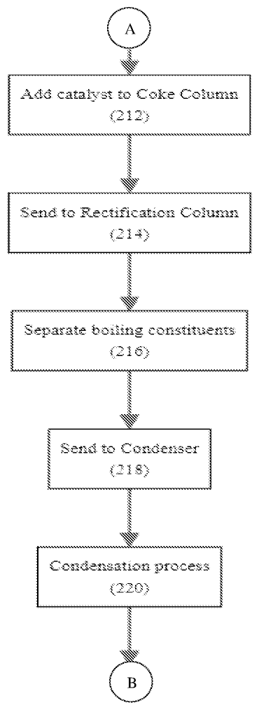

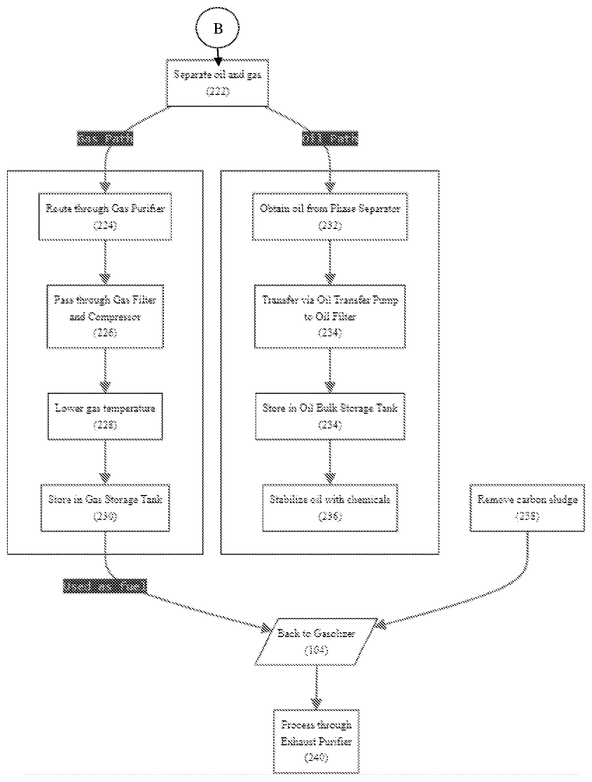

FIG. 2 illustrates the process 200 through a flow diagram for converting the plastic material to the one or more hydrocarbon products.

In step 202, comprises of adding the plastic material to the Gasolizer 104 along with the catalysts. The plastic material is added in shredded or crushed or densified form. The plastic material is added to the Gasolizer 104 via specially designed densified or granulated plastic waste. Also, the catalysts are added to the Gasolizer 104, wherein the catalysts are taken in the ratio of 0.1 to 0.2% with the plastic material.

In step 204, using the heat source the Gasolizer 104 is heated at the temperature range of 360 to 380° C. and at atmospheric pressure and in the absence of the oxygen. At this step 204, system depolymerizes plastic and converts to hydrocarbon vapors and carbon (sludge).

In step 206, the Gasolysis™ reaction takes place inside the Gasolizer 104 due to heating. The Gasolysis™ reaction generates the hydrocarbon vapors of the molten plastic material under predetermined temperature and at atmospheric pressure. Due to the Gasolysis™ reaction the catalytic cracking takes place inside the Gasolizer 104, wherein the catalytic cracking enables the long polymeric chains of the plastic material to break into smaller polymeric chains.

In step 208, the hydrocarbon vapors comprising of oil (Hydrocarbon Vapors) vapors, a gas and solid carbon particles are passed to the Coke Column 106, wherein the Coke Column 106 is attached to the Gasolizer 104.

In step 210, the solid carbon particles from the hydrocarbon vapors are separated from the oil vapors and the gas inside the Coke Column 106. When the hydrocarbon vapors are introduced in the Coke Column 106 from the bottom end the hydrocarbon vapors are exposed to an environment inside the Coke Column 106 where lighter constituents of the hydrocarbon vapors are raised higher in the height than the heavier constituents like the solid carbon particles of the hydrocarbon vapors due to lowering of the speed of the hydrocarbon vapors with which the hydrocarbon vapors entered the Gasolizer 104. The Coke Column 106 contains an outlet at the top end from where relatively lighter hydrocarbon vapors and the gas are taken out and transferred to the Rectification Column 108. The heavy solid carbon particles are settled at the bottom of the Coke Column 106 and thereafter eventually dropped to the Gasolizer 104 again for re-processing.

In step 212, a catalyst to the Coke column (106) has been added to accelerate the process. The catalyst, which is selected from the group of alumina and silicates-based catalyst group, is added in the ratio of 0.1 to 0.2%.

In step 214, after separating out the solid carbon particles in the step 210, the gas and the oil vapors are sent to the Rectification Column 108 for separating out the high boiling constituents and the low boiling constituents of the oil vapors. At this step 210, recycling of the high boiling wax takes place by routing them back to Gasolizer 104. This is achieved by routing the oil vapors and the gas from the Coke Column 106 through the Rectification Column 108, wherein low and high boiling constituent from oil vapors can be separated and thereafter through the Online Reflux System 110 to ensure maximum recycling of the high boiling wax.

In step 216, the high boiling constituents and the low boiling constituents of the oil vapors are separated by the Rectification Column 108.

In step 218, the low boiling constituents which are separated in the step 214 are sent to the Condenser 112.

In step 220, condensation of the low boiling constituents of the oil vapors results in one or more hydrocarbon products in liquid state and the gases remains un-condensed in gaseous state. The un-condensed gases are separated from the one or more hydrocarbon products by using the Phase Separator 118.

In step 222, cooled oil and the gas in the step 218 are separated in the Phase Separator 118.

In step 224, separated gas is routed through the Gas Purifier 120, wherein the Gas Purifier 120 further contains the packing of materials like copper or cuprous like material pieces to special metal packings remove impurities and to obtain pure form of gas.

In step 226, the pure form of gas is passed through the Gas Filter 122 followed by the Compressor 124.

In step 228, the gas temperature is lowered which is increased during the compression in the Compressor 124.

In the step 230, compressed gas is stored in the Gas Storage Tank 128. Further, the stored gas from the Gas Storage Tank 128 is utilized as a fuel to run the Gasolizer 104.

In the step 232, obtaining the oil from the Phase Separator 118.

In the step 234, the oil obtained from the Phase Separator 118 is transferred to the Oil Filter 134 using the Oil Transfer Pump 132 and ultimately stored in the Oil Bulk Storage Tank 136. Also, oil remains of from the Gas Storage Tank 128 is also collected in the Oil Bulk Storage Tank 136 which ensures no wastage of the oil obtained.

In step 236, stabilizing of the oil obtained from the Phase Separator 118 is performed by circulating a chemical throughout to neutralize the pH of the oil and oil washing. The chemical used would be acids, base or additives.

In step 238, carbon (in the form of sludge) is continuously removed using the Sludge Removal 140 while ensuring the smooth functioning of the Gasolizer 104.

In step 240, flue gases coming out of Gasolizer 104 are passed through the Exhaust Purifier 142 to obtain the clean flue gas which can then be released in the atmosphere at the recommended height.

In view of the variety of embodiments of the present disclosure, it will be appreciated that various modifications or changes can be made in the preferred embodiments without departing from the principle of the disclosure. These and other modifications in the nature of the disclosure or the preferred embodiments will be apparent to those skilled in the art from the disclosure herein. It is to be particularly understood that the former descriptive matter is to be interpreted merely as illustrative of the disclosure and not as a limitation.

We claim:

1. An assembly 100 of an augmented attachments integrated in a process 200 for converting a polymer to one or more hydrocarbon products, characterized in that:
a feeding means coupled vertically through inlets to the Gasolizer (104), adapted to feed shredded or densified (agglomerated) or granulated polymer to a Gasolizer (104), wherein feed rate of the feeding means is controlled through a cooled gate valve and/or a Rotary Air Lock Valve (RALV) to ensure oxygen free reaction inside the Gasolizer (104);
an impounding means, adapted to arrest contaminants present in the hydrocarbon vapors coming out of a Phase Separator (118), wherein the impounding means further comprises of a metal packaging to facilitate active arrest of the said contaminants;
a reflux means, adapted to convert hydrocarbon vapors coming out of the Gasolizer (104) and Rectification Column (108) into a condensate.

2. The assembly 100 of an augmented attachments as claimed in claim 1, wherein the reflux means through condensation further aids in maintaining the overall temperature of the process for converting a polymer to one or more hydrocarbon products.

3. A process 200 conducted using the assembly 100 of an augmented attachments, the process further comprising:
adding the polymer to a Gasolizer (104), wherein the polymer is in shredded or densified (agglomerated) or granulated form;
depolymerization of the polymer in the Gasolizer (104), wherein the depolymerization comprises of a Gasolysis™ reaction at a predefined temperature of 360° to 380° C. at the atmospheric pressure and in absence of oxygen inside the Gasolizer (104), wherein the depolymerization further comprise heating of the polymer in presence of a catalyst to enable to generate hydrocarbon vapors comprising oil vapors, a gas, and solid carbon (sludge) particles;
passing the hydrocarbon vapors from the Gasolizer (104) to a Coke Column (106) in order to separate the solid carbon particles from the oil vapors and the gas;
adding a catalyst and special metal packing materials to the Coke Column (106), wherein the catalyst is added in the ratio of 0.1 to 0.2%;
passing the oil vapors and the gas from a Rectification Column (108) to separate the high boiling constituents and the low boiling constituents of the oil vapors and the gas, wherein
a) the solid carbon particles are passed to the Gasolizer (104) for re-processing, and
b) the oil vapors and the gas are passed to a reflux means;
passing the low boiling constituents of the oil vapors and the gas to a Condenser (112), through a special metal packing material added to the Rectification Column (108), wherein the oil vapors are condensed in the Condenser (112) to obtain the one or more hydrocarbon products and the gas;
separating the one or more hydrocarbon products along with moisture and the gas by passing through a Phase Separator (118);
purifying the gas obtained from the Phase Separator (118) using a filtering means, wherein the filtering means further comprises of the special metal packaging material to obtain pure form the gas;
cooling the pure form of the gas using a Gas Cooler (126), wherein the pure form of the gas after cooling is utilized as a fuel to run the Gasolizer (104) or utilizing for further applications as per need;
obtaining the oil from the Phase Separator (118);
stabilizing the oil obtained from the Phase Separator (118) by circulation of the oil and with added chemicals to neutralize the pH of the oil and washing of oil produced; and
releasing flue gases coming out of the Gasolizer (104) into the environment after passing them through Exhaust Purifier (142).

4. The process 200 as claimed in claim 3, wherein the polymer comprises at least one of a Polyethylene (PE) High-Density Polyethylene (HDPE), a Low Density Polyethylene (LDPE), a Polypropylene (PP), a Polystyrene (PS), or multilayer plastic waste segregated from municipal solid wastes or packaging industry waste or a combination thereof.

5. The process 200 as claimed in claim 3, wherein the process for converting a polymer into one or more hydrocarbon products is a continuous process, which includes continuous feeding of the polymer, continuous generation of hydrocarbons and continuous removal of residue (carbon/char).

6. The process 200 as claimed in claim 3, wherein the chemicals used to stabilize the oil is acids or base or other additives.

7. A process 200 as claimed in claim 3, wherein the catalyst is selected from the group of alumina and other FCC Zeolites, rare earth metals catalyst.
